(19) United States
(12) Patent Application Publication
(10) Pub. No.: US 2014/0337208 A1
(43) Pub. Date: Nov. 13, 2014

(54) PARTNER PORTAL SOLUTION FOR FINANCIAL SECTOR

(71) Applicant: INFOSYS LIMITED, Bangalore (IN)

(72) Inventors: Rajashekara Visweswara MAIYA, Bangalore (IN); Chandramouli KUNDAGRAMI, Bangalore (IN)

(21) Appl. No.: 14/314,217

(22) Filed: Jun. 25, 2014

Related U.S. Application Data
(62) Division of application No. 13/519,536, filed on Aug. 20, 2012.

(51) Int. Cl. G06Q 20/10

(52) U.S. Cl. CPC G06Q 20/108
USPC 705/42

(57) ABSTRACT

A banking portal system including a processor, memory coupled to the processor, a configuration storage including configuration data stored in a computer-readable storage medium, the configuration data including user information for a plurality of users registered with the banking portal system, where the plurality of users are from partner organizations of different business partner types including retail partner, regulator partner, and prospect partner; and portal functionality for conducting transactions with a bank in conjunction with the partner organizations, where the portal functionality includes retail-partner-specific functionality, regulator-partner-specific functionality, and prospect-partner-specific functionality.

### CROSS-REFERENCE TO RELATED APPLICATION

This application is a divisional of U.S. patent application Ser. No. 13/519,536 filed on 27 Jun. 2012 under 35 U.S.C. 371 as the U.S. National Stage of International Patent Application Number PCT/IN2010/000862 filled on 29 Dec. 2010 which claims the benefit of Indian provisional patent application 3237/CHE/2009 filed 30 Dec. 2009, all of which said applications are herein incorporated by reference in their entirety.

### BACKGROUND

Portals became popular as a result of the dot-com era In the first stages of portal evolution, institutions wanted a single page through which to share different types of content with stakeholders. The portals started as engines for content aggregation. Companies such as Microsoft and Yahoo! made portals popular, with their websites becoming portal pages. Later, portals were used to provide links to useful content through the portal infrastructure. Such was the beginning stage of portals.

As the Internet became more encompassing, another stage of portal evolution emerged, triggered by the need to have more integrated application systems, as well as a common gateway for all stakeholders. Another business necessity was to reduce duplication of work for the partner as well as the institution, thus improving efficiency and productivity. Portals became common infrastructure to provide access to customer and partner applications. There was a movement from applications which did content aggregation to applications which were more transactional in nature.

Although there have been a variety of advances, there remains room for improvement.

### SUMMARY

A variety of innovative techniques can be used for implementing partner portals. A dynamic and robust partner portal can support a wide variety of partner types and partner functions. Significant benefits can accrue from such partner portals such as, for example, increased efficiency, revenue, customer retention, and the like.

For example, partner portal infrastructure technologies can support registration, validation, rights, and targets for partners.

The partner portal architecture can include common access functions, generic framework functions, co-partnering functions, and other functions as described herein.

Functionality such as setting up partners (e.g., setting up master details for a partner), granting rights to partner users (e.g., performing partner role-based access control), and partners conducting transactions in conjunction with the portal principal (e.g., principal-partner collaborative workflow) can be supported.

Via the partner portal, partners can originate the process of customer creation and validation. Back office functions such as approval can be performed by the bank. Such an approach allows co-branding and added customer benefits due the partner's relationship with the bank.

The partner portal can also support partner incentives. For example, a partner can be rewarded for bringing new customers to the bank.

The portal can push queries to independent service providers to facilitate sale of financial products.

Product selling restrictions can be supported.

As described herein, a variety of other features and advantages can be incorporated into the technologies as desired.

The foregoing and other features and advantages will become more apparent from the following detailed description of disclosed embodiments, which proceeds with reference to the accompanying drawings.

### BRIEF DESCRIPTION OF THE FIGURES

FIG. 1 is a block diagram of an exemplary system implementing the partner portal technologies described herein.

FIG. 2 is a flowchart of an exemplary method of implementing the partner portal technologies described herein.

FIG. 3 is a block diagram of an exemplary partner portal architecture.

FIG. 4 is a flowchart of an exemplary method of implementing the partner portal technologies described herein.

FIG. 5 is a flow diagram illustrating a customer coming to a retailer to purchase white goods.

FIG. 6 is a diagram of an exemplary process for partner empanelment via a partner portal.

FIG. 7 is a diagram of an exemplary process for product selling restrictions via a partner portal.

FIG. 8 is a diagram of an exemplary process for independent financial advising via a partner portal.

FIG. 9 is a diagram of an exemplary process for creation of a customer information file via a partner portal.

FIG. 10 is a diagram of an exemplary process for maintaining customer information file details for an existing customer via a partner portal.

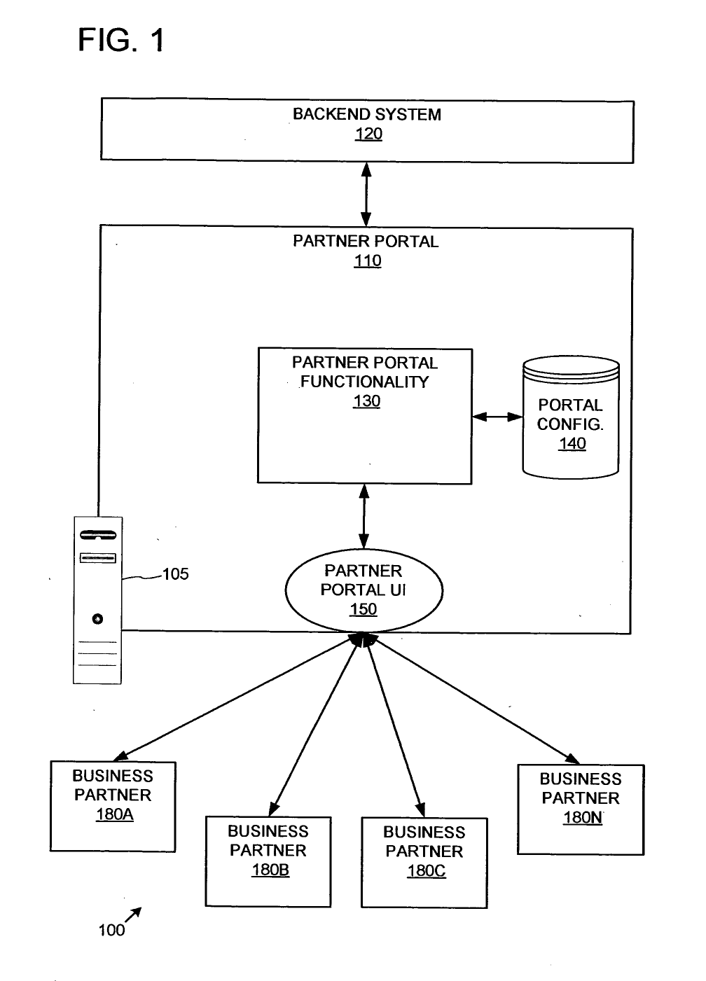

FIG. 1 1 is a diagram of an exemplary process for opening a new account via a partner portal.

FIG. 12 is a block diagram of an exemplary computing environment suitable for implementing any of the technologies described herein.

### DETAILED DESCRIPTION

### Example 1

### Exemplary Overview

The technologies described herein can be used for a variety of partner portal scenarios.

### Example 2

### Exemplary Partner Portal System

FIG. 1 is a block diagram of an exemplary system 100 implementing the partner portal technologies described herein. In the example, one or more computers in a computing environment 105 implement a partner portal 1 10 for access by a plurality of business partners 180A-N.

The partner portal 110 allows the business partners to access various partner portal functionality 130 via a partner portal user interface 150. Various processes can be supported by a backend system 120.

The portal configuration store 140 can store any of a wide variety of configuration information as described herein (e.g., related to the partners 180A-N and the functionality 130).

In practice, the systems shown herein, such as system 100 can be more complicated, with additional functionality, more partners, and the like.

In any of the examples herein, the portal configuration 140 and other partner portal information can be stored in one or more computer-readable storage media.

### Example 3

### Exemplary Partner Portal Method

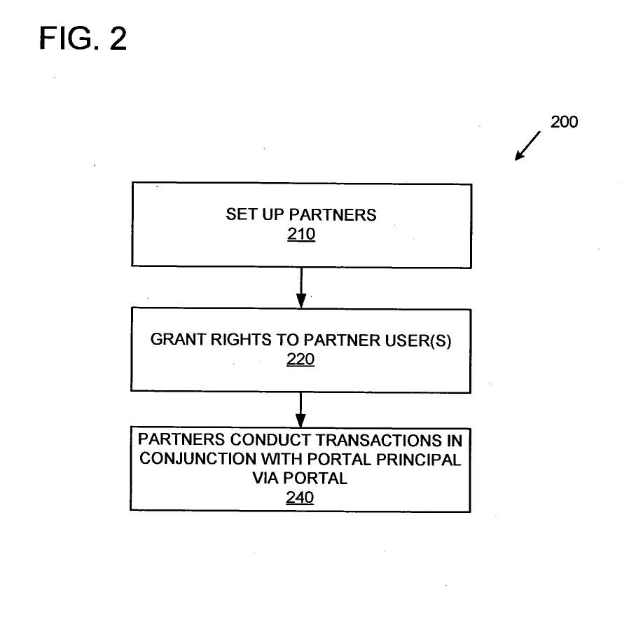

FIG. 2 is a flowchart of an exemplary method of implementing the partner portal technologies described herein and can be implemented, for example, in a system such as that shown in FIG. 1. The technologies described herein can be generic to the specifics of operating systems or hardware and can be applied in any variety of environments to take advantage of the described features.

At 210, partners are set up according to any of the techniques described herein. For example, a. partner organization can register with the partner portal, and information related to the partner organization can be stored in the partner portal configuration store.

At 220, rights are granted to partner users via any of the techniques described herein.

Although rights can be granted by the portal principal, as described herein, rights can be administered by the partner organizations. Thus, directives to grant rights to partner users can be received from partner users who are authorized to administer rights for the partner (e.g., on behalf of the portal principal). Role-based access control can be implemented. Partner users can be assigned various roles which dictate the access allowed by the user.

At 240, partners conduct transactions in conjunction with the portal principal via the portal. For example, the users to whom rights have been granted can conduct any of the operations described herein to facilitate transactions involving the partners, customers, and the portal principal. Such users can be partner users, thus allowing directives to conduct business or start business workflow to be received from partner users.

The method 200 and any of the methods described herein can be performed by computer-executable instructions stored in one or more computer-readable media (e.g., storage or other tangible media) or one or more computer-readable storage devices.

### Example 4

### Exemplary Partner Portal Architecture

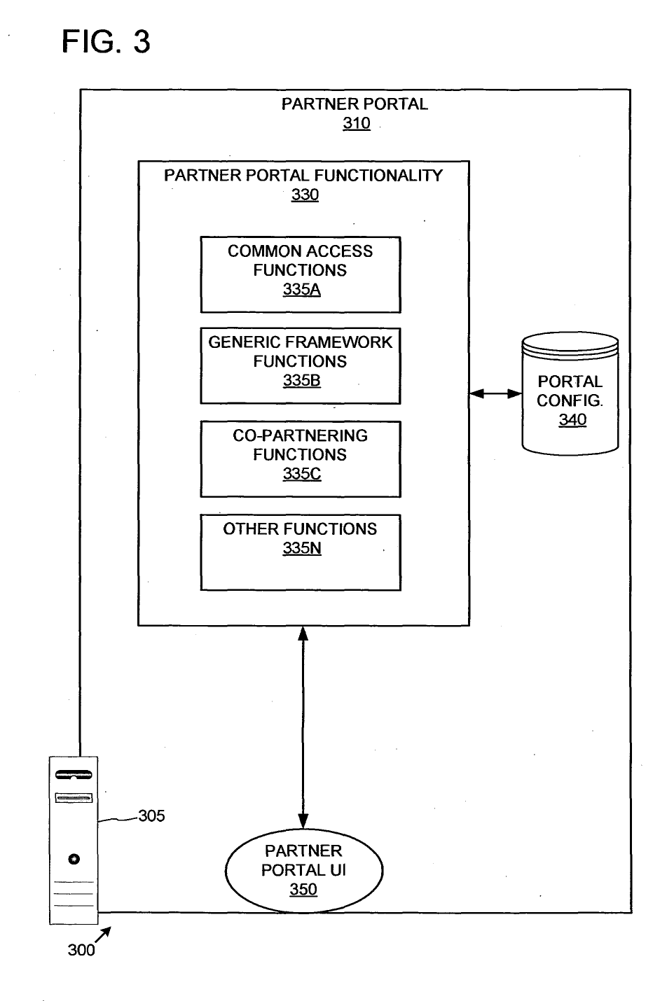

FIG. 3 is a block diagram of an exemplary partner portal architecture 300. In the example, one or more computers in a computing environment 305 implement a partner portal 310, which can implement any of the partner portals described herein (e.g., the partner portal 110 of FIG. 1).

In the example, a user interface 350 provides access to various functionality 330 of the partner portal. The portal configuration store 340 can store any of the configuration information described herein.

The exemplary configuration comprises various modules 335A-N for implementing partner portal functionality.

The common access functions module 335A can implement any of the common access functions described herein, including access control and partner management.

The generic framework functions module 335B can implement any of the generic framework functions described herein, including administrative functionality, incentive and commission calculation, and ad hoc reports generation.

The co-partnering functions module 335C can implement any of the co-partnering functions described herein, including partner collaboration workflow and assigning workflow for co-partners.

Modules 335N for other functions can implement any of the other functionality described herein, including, in one or more modules, common infrastructure, dashboard, common alert mechanism, multi-mode operation, service capabilities, and the like.

### Example 5

### Exemplary Partner Portal Method

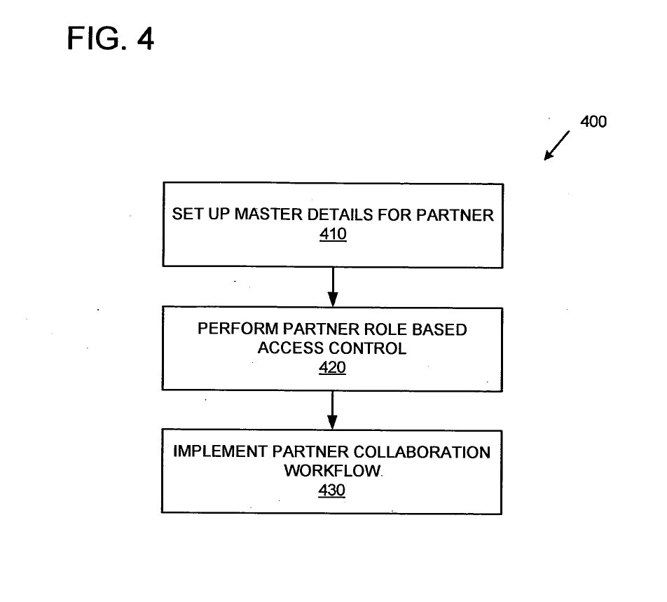

FIG. 4 is a flowchart of an exemplary method of implementing the partner portal technologies described herein.

At 410, master details for a partner are set up according to any of the examples described herein. For example, a partner name, partner type, and various other related information (e.g., incentive scheme) can be received by the partner portal system.

At 420, role-based access control is performed for the partner according to any of the examples described herein. For example, the portal principal can open up access to the partner depending on the partner type. The partner administrator can then restrict partner users with access based on the roles or responsibilities they perform within the partner organization.

At 430, partner collaboration workflow is implemented according to any of the examples described herein. Multiple partners can provide part service to the partner principal. Partners themselves can service a customer through multiple partners through the portal. For example, a partner can route a customer request to a third party, who in-turn performs tasks (e.g., billing) with respect to the portal principal. Any of the incentive techniques and targets can be implemented in conjunction with collaboration workflow. For example, credit can be given to a partner who drives a customer to another partner who in turn brings a new customer to the portal principal.

### Example 6

### Exemplary Business Partners

In any of the examples herein, the partner portal can support a wide variety of business partners (or simply “partners”) of the portal principal. Such partners are not limited to those having a legal partnership relationship with the portal principal.

Such partners can include direct selling agents, retailers, regulators, travel agents, prospectors, broker/agents, and others, including independent service providers and the like.

In any of the examples herein, the partner portal may be extended to include at least one of a supplier, a vendor, a solicitor, an auditor, a central bank investigator and inspectors, a regulator, or combinations thereof.

### Example 7

### Exemplary Partner Types

In any of the examples herein, a partner type can be defined to differentiate various partners. The partner type can be stored as an identifier of the type of partner in the portal configuration store (e.g., as associated with the respective partner). Some partners may perform multiple roles and so may have multiple partner types.

### Example 8

### Exemplary Partner Portal Configuration Data

In any of the examples herein, partner portal configuration data can be stored (e.g., in a configuration store) to control various aspects of the portal. For example, access control, partner information, and the like can be stored.

### Example 9

### Exemplary Transactions

In any of the examples herein, transactions can be conducted with the portal principal, with partners, among partners, and the like. Such transactions can be any of a wide variety of business transactions associated with the financial sector (e.g., applying for a loan, opening an account, ordering selling supplies/services, providing advice, and the like).

### Example 10

### Exemplary Backend System

In any of the examples herein, a backend system can support the partner portal. For example, in a banking context, the Finacle™ technologies of Infosys Technologies Ltd. can be used. Other systems can serve a similar role.

### Example 11

### Exemplary Partner Portal User Interface (VI)

In any of the examples herein, a user interface to the partner portal can be implemented via web-based technologies. For example, a uniform resource locator can be used to access a web page that serves as entry to the portal.

### Example 12

### Exemplary Organization

In any of the examples herein, an organization can be a business entity or business enterprise, whether for profit or non-profit. Other variations include a subdivision or department of a larger business entity. The organization can be an internal client of a larger business entity.

### Example 13

### Exemplary Portal Principal

In any of the examples herein, a portal principal can be the organization responsible for overall administration of the partner portal. For example, a financial institution can administer the partner portal for its own benefit. In practice, various administrative tasks can be delegated to business partners of the bank, allowing the partners to directly take on such tasks.

An information technology service provider can perform any of the portal principal actions described herein as desired on behalf of the portal principal as part of a service agreement.

As described herein, the portal principal can be a financial institution. As such, the financial institution can leverage the partner portal to its benefit to increase market share, offer additional services, and otherwise improve its business, profitability, revenue, and the like.

Also as described herein, the principal may be a single banking entity operating across different geographies, a collection of different banking entities that have come together under a single umbrella, or a combination thereof. For sake of convenience, the partner principal is sometimes referred to simply as the “bank,” the “financial institution,” or the “originating organization.”

### Example 14

### Exemplary Financial Institution

In any of the examples herein, a financial institution can be a bank, credit union, savings and loan, or other organization engaging in banking activities.

### Example 15

### Exemplary Financial Products

In any of the examples herein, financial products can include loans (e.g., mortgage, consumer loan, and the like), deposit accounts (e.g., savings, checking, certificates of deposit, and the like), investment products, insurance, currency exchange, and the like. Applicable governmental and other regulations regarding the sale, advertisement, and administration of such products are observed by the portal.

### Example 16

### Exemplary Implementations

Any of the technologies herein can include methods and systems to symbiotically integrate a financial institution(s) with one or more partners on a unilateral platform to provide collaborative services through a partner portal solution.

### Example 17

### Exemplary Implementation: Portal

Generally, a portal can be implemented as a website that aims to be an entry point to the World Wide Web. Portals gained popularity after the dot.com era. Portals can share business information, offer a means to conduct business transactions, or both.

Conventional portals intended for sharing business information generally include single page content, thus providing stakeholders and/or employees with access to documents and business information, and not to live applications. Such portals are sometimes called “first evolutionary stage” portals. As the Internet became more encompassing, the second stage of portal evolution emerged. At this stage of evolution, more integrated application systems were developed and deployed to partners and customers through portals for offering business transactions.

Second stage portals helped to improve efficiency and productivity and reduce duplication of work for the partner, customers, and portal principal. Thus, portals evolved from documents or information only for employees or stakeholders to applications for customers and partners. The partner portal can be a gateway through which partners connect with an originating organization (e.g., the partner principal).

In some portals, partners can be given access based on the function involved. The integrated applications are transparent to the partners, and access is provided to one or more applications and tools relevant for the organization and role. There may be a single sign-on mechanism used to sign-on the user, and based on the organization and the role of the partner, access to one or more tools and the required applications are provided.

The partner portals employed in financial services can allow partners to login to conduct business transactions on behalf of the partners. For example, a mortgage broker logged in to the partner portal may be allowed to transfer information about prospects sourced from the market, or a plastic manufacturer logged in to the partner portal may be allowed to download the list of new cards to be issued or replaced and also to upload the list of cards dispatched with the relevant details. Similarly, a check book printer logged in to the partner portal may be allowed to upload or download relevant information about its transactions with the bank.

Some integrated applications deployed through the partner portal for offering business transactions may not have any interaction capabilities. Generally, such partner portals only provide the relevant front end for dealers to operate with the originating organization and may hide or de-activate the rest of the front end for dealers to operate. Essentially, a specific partner is allowed access only to the application (and screens) relevant for specific transactions with seamless interface to the rest of the business process. Thus, such partner portals only open a small part of the window, relevant for a specific partner.

If the mortgage partner is required to view the status of the uploaded mortgage application or why a particular mortgage application is pending in the bank, this information might not be accessible by the mortgage partner on such a partner portal. Instead, the mortgage partner needs to call or email the bank to obtain the information. The business processes across such applications are silo based, and may not cut across different applications.

Organizations are focusing on their business processes, their efficacy and efficiency and also need to cut down their turnaround time for conducting business transaction through partner portals. Also, organizations are exploring ways and means to leverage cross functional collaboration between partners, customers and institutions.

Thus, there is a rigorous need for another stage of portal evolution that includes an integrated application that automates complex business processes through integrated partner portals for increasing the efficacy and efficiency of the organization. Also, there is a need to provide ways and means for functional collaboration between partners, customers and institutions to make business processes more seamless and smooth. Organizations also require partner portals for integrating and managing access to disparate applications and content sources.

### Example 18

### Exemplary Summary: Partner Portal

Methods and systems for symbiotically assimilating a financial institution(s) with one or more partners on a unilateral platform to provide collaborative services through a partner portal solution are presented.

In any of the examples herein, an integrated partner portal for a financial institution can include providing one or more collaborative services and extending the accessibility of these services to one or more partners for providing more business points in the system. The collaborative services can include at least one of: 1) common access features, 2) generic framework, 3) common infrastructure requirements, 4) dashboard functions, 5) common alert mechanism, 6) co-partnering, 7) multi mode operation, 8) service capabilities, or combinations thereof.

In any of the examples herein, a partner of the financial institution can include at least one of a direct selling agent (DSA), a retailer, a regulator, a travel agent, a prospector, a broker and agent, a custom partner, or combinations thereof.

In any of the examples herein, partners may have a corresponding functionality along with one or more extended collaborative services with the different parties involved. For instance, a partner may collaborate with other partners or bank officials. This access to collaborate can be setup by the bank based on the business functions the partners are performing with respect to the bank.

In any of the examples herein, the partner portal provided by the financial institution can be employed to support the entire partner ecosystem, which includes dealers as well as suppliers of the bank.

In any of the examples herein, the integrated partner portal may be extended to include at least one of a supplier, a vendor, a solicitor, an auditor, a central bank investigator and inspectors, a regulator, or combinations thereof.

In any of the examples herein, through an integrated partner portal and integration with backend (e.g., Finacle™ UBS, i.e. Finacle Universal Banking Solution) components, the aspect of

partner relationship management (PRM) and financial products may be leveraged across businesses and at a very cost effective business scenario extending to the last bit of customer induction point. Additionally, the partner portal can include an infrastructure to integrate an enterprise PRM solution and one or more application components of the backend.

### Example 19

### Exemplary Implementation: Portal

In any of the examples herein, an integrated partner portal for a financial institution can include providing one or more collaborative services and extending the accessibility of these services to one or more partners for providing more business points in the system.

In any of the examples herein, the collaborative services can include at least one of the following: 1) common access functions, 2) generic framework functions, 3) common infrastructure requirement functions, 4) dashboard functions, 5) common alert mechanism functions, 6) co-partnering functions, 7) multi mode operation functions, 8) service capabilities functions, or combinations thereof.

In any of the examples herein, the collaborative services can be provided from at least one of the financial institution or one or more partners or combinations thereof.

### Example 20

### Exemplary Common Access Functions

In any of the examples herein, the common access function can include the financial institution's providing control features of the partner. Similarly, the common access function can include the partner's providing a partner administrative access defining partner role-based access control. The financial institution (e.g., bank) can provide high level access control opening up just that much of the application that the partner is required to use. The partner admin can then restrict the users with access, based on the roles or responsibilities they perform within the partner organization.

In any of the examples herein, the common access features can include a) an access control feature, b) a partner management framework feature, or combinations thereof.

The access control feature provided by the financial institution can include administrative access of the partner features, a grant or revoke products and services feature, and a partner accessibility feature, or combinations thereof. Similarly, the access control feature provided by the partner can include an access control feature for various partner roles. The partner roles may comprise a partner administrator, a partner manager workgroup, a partner agent, a partner subagent, or combinations thereof. Additionally, the access control feature may allow privileged access to the services, products, and reports assigned for each role. Also, it may grant/revoke products and services.

The partner management framework feature provided by the financial institution can include a provision for the financial institution to define new partners or assign the defined partner different roles, which can include a partner class, a partner type, or combinations thereof. Also, the partner management framework feature can include the financial institution defining partner entities and sub entities, attaching partnering function and creating workflow for the new partner, providing access controls for the partner, or combinations thereof.

### Example 21

### Exemplary Generic Framework Functions

In any of the examples herein, the generic framework function can include a) an administrative functionality feature, b) an incentive and commission calculation feature, c) an ad hoc reports generation feature, or combinations thereof.

The administrative functionality feature of the financial institution can include provision to manage the partner related settings. The management of the partner related settings can include at least one of setting up master details for the partner, providing access to additional partner entities, associating partner accounts for banking related transactions (e.g., payment of commissions and incentives), providing partner hierarchy management, setting up workflow for the partner, or combinations thereof. Similarly, the administrative functionality feature of the partners can include providing the partner administrator an internal partner setup control functionality. The internal partner setup can include at least one of hierarchy management functionality, a target and limit setting functionality for internal partner workgroups, setting up incentive and commission payouts functionality, adding workflow for its internal partner workgroup functionality, or combinations thereof.

The incentive and commission calculation feature can include provision for incentive and commission calculation and management capabilities for the financial institution and as well to the partners. So, setting up partners can include setting up a type of incentive scheme for the partner or the types of incentive schemes for which the partner is eligible (e.g., from which the partner can select).

The ad hoc reports generation feature of the financial institution can include a reporting mechanism to provide ad hoc custom reports which can comprise at least one of a compliance related reports on partners, consolidated regulatory, governance reports on partners, or combinations thereof. Similarly, the ad hoc reports generation feature of the partners can include a report generating module to provide at least one of an ad hoc report to the bank for GRC adequacy, an ad hoc interim financial report for regulatory reporting, an ad hoc transaction report for bank's reconciliation, or combinations thereof. The ad hoc reports may also include reports on partners about their targets and their performance parameters.

### Example 22

### Exemplary Common Infrastructure Requirement Functions

In any of the examples herein, the common infrastructure requirement functions can include a) a multilingual feature, b) a multi entity feature, c) a multi currency exchange rates feature, d) a multi channel feature, or combinations thereof.

The multilingual feature of the financial institution can include providing a multilingual interface for the banking operations. Similarly, the multilingual feature of the partners can include providing a multilingual interface for the partner operations. The multilingual feature can enable interface screens to be displayed in a local language.

The multi entity feature of the financial institution can include providing a multi entity banking environment. The multi entity feature may help association of multiple banks under the umbrella of the same bank or same bank across different geographies to use banking software (e.g., Finacle™) in a single hosting environment. Also, multiple banks can engage a single partner or different partners in multi entity scenario. Similarly, the multi entity feature of the partners can include providing multi entity banking environment.

The multi channel feature of the financial institution can include providing operating capabilities through multiple channels. The partner network can be Internet based, both online and offline mode. Also, the partner network can be available over mobile devices and centralized partnering branch offices. Similarly, the multi channel feature of the partners can include providing operating capabilities through multiple channels and modes. This can include both online offline capabilities. Additionally, the partner marketing can be provided through kiosk, emails, fax, or combinations thereof.

### Example 23

### Exemplary Dashboard Functions

In any of the examples herein, the dashboard functions can include a partner dashboard feature. The partner dashboard feature provided by the financial institution can include providing a single screen with the key information regarding that particular partner. The bank partner dashboard may show the associated partners of the bank. Also, upon selecting the particular partner, the bank user is able to view the partner details and partner management module for partner servicing. Similarly, the partner dashboard provided for the partner may have a role up feature. Additionally, the partner dashboard feature may provide the access based dashboard for each level of partner workgroup.

Further, it may also provide agents, sub agents, and partner manager workgroups different dashboards based on their role and access privileges.

### Example 24

### Exemplary Common Alert Mechanism Functions

In any of the examples herein, the common alert mechanism functions can include an alerts and broadcast feature. The common alert mechanism can enable the financial institutions to provide, via the portal, a common alert infrastructure by which events and news may be broadcasted to the partner (e.g., ticker or flash board). Additionally, an interest rate drop or introduction of new product or discontinuing existing product (e.g., ticker or flash board) may also be broadcasted. The common alert mechanism may even have the provision to broadcast a blacklisted customer or agent (e.g., Flash Alert). Similarly, the common alert infrastructure of the partner may broadcast an alert to bank employees if a customer is engaged in fraudulent or suspicious activities (e.g., trying to get double quotes from two individual DSAs or target achieved status). Additionally, it may alert the bank to any security, fraud, or external risk elements and provide an avert mechanism (e.g., socio-government changes, environmental factors, terrorist attack, etc.). This alert mechanism may be configured by the partner on the partner portal itself.

### Example 25

### Exemplary Co-Partnering Functions

In any of the examples herein, the co-partnering functions can include a partner collaboration feature. The partner collaboration feature may provide a financial institution with co-partnering or partner collaboration workflow. Also, the partner collaboration feature may allow multiple partners to provide part service to the bank. It may also provide a flexible mode of assigning workflow for co-partners. Similarly, the partners may have capability to service a customer through multiple partners. For example, a DSA can route a customer request to an insurance agent, who in-turn performs the billing transaction with the bank. Additionally, co-partnering capabilities or transfer mechanisms in the workflow may allow customers to be serviced through multiple partners. Also, revenue sharing/incentive sharing model may be used along with the workflow.

### Example 26

### Exemplary Multi Mode Operation Functions

In any of the examples herein, the multi mode operation functions can include an online offline capability feature. The financial institution and partners can be connected over various channels. The partners may have an extended online/offline capability to reach customers at remote locations.

Offline capability can allow basic data capture or product and service look up. Customer data captured in offline mode can be synced up in online synchronization of mobile device.

### Example 27

### Exemplary Service Capabilities Functions

In any of the examples herein, the service capabilities functions can include: a) workflow transparency feature, b) an external system connectivity capabilities feature, c) a usability and end to end customer servicing feature, or combinations thereof.

The workflow transparency feature of the financial institution can include providing workflow transparency. A majority of services may be available for the bank to be provided to the partners through the workflow, e.g. includes creating invoices and viewing suppliers or vendors. The financial institution may provide flexible banking transactions to the partner and also flexibly accommodate partners in the banking ecosystem. Similarly, the partners may have capability to provide transaction transparency to the bank. The partners may service customers at a high-level of financial and banking transparency. For example, customers may apply for a loan or for insurance; and process flow and status tracking may span across partners. Also, the functions can provide flexible workflow revenue sharing/incentive sharing model to the financial institution.

The external system connectivity capabilities feature may enable the partner portal to interface with an external system (e.g., Enterprise Resource Planning, Supply Chain Management, or the like) to pool transaction data, account receivables and process them in online and batch mode operations.

The usability and end to end customer servicing feature may enable the partner portal to reuse components to add new partners, copy/edit existing workflow, and use existing infrastructure to accommodate banking partners to provide end to end servicing to the customer of the bank.

### Example 28

### Exemplary Partners

In any of the examples herein, the partner of the financial institution can include at least one of a) a direct selling agent (DSA), b) a retailer, c) a regulator, d) a travel agent, e) a prospector, f) a broker and agent, or combinations thereof. Each partner may have a corresponding functionality along with one or more extended collaborative services.

The partners of the financial institution are the ones who are in some business communication or relation with the institution. In any of examples herein, the partner of the financial institution may additionally include suppliers and service providers. Similarly, there may be more partners to the bank, and the partner details described herein should not be read to restrict the scope of the technologies in light of the number of partners with whom the financial institution may partner.

### Example 29

### Exemplar Web 2.0 Tools

In any of the examples herein, Web 2.0 tools can include at least one of a) chat—push to talk feature, b) blog feature, c) wiki feature, d) RSS feature, or combinations thereof.

In any of the examples herein, the chat—push to talk feature may be used to communicate with resources from the partner bank and partner internal resources to manage the workflow and handle customer queries getting inputs from subject matter experts.

In any of the examples herein, the blog feature is an internal forum to post information regarding business, new product launches and helpful information that will add value to the partner workgroup entities. In any of the examples herein, the wiki feature may be used as a guide link for basic queries on the partner roles and functions and generic queries on the products offered to the customers. In any of the examples herein, the RSS feed may additionally connect the partners to the outside forum regarding partner partnering products and product news.

In any of the examples herein, the functionality of the Web 2.0 tools may be used across the partner of the financial institution. The partners can include any of those described herein.

### Example 30

### Exemplary DSA Functionality

In any of the examples herein, the functionality of the DSA can include at least one of a) a partner SSO login function, b) DSA dashboard function, c) group function, d) reports function, e) tools function, f) Web 2.0 tools function, or combinations thereof.

In any of the examples herein, the one or more functions which may be finally implemented at the partners end may depend on the requirement of the partners and also the functionality may be configurable based on partner type and requirement. The scope of the functionality should not be read as restrictive in light of the present description.

In any of the examples herein, the partner SSO login function can allow the DSA partner to use partner SSO to login to the system. The welcome screen can be the DSA dashboard.

In any of the examples herein, the DSA dashboard function can be a common view for the activities for the DSA. It may include at least one of a finance management, an incentive management, tools (e.g., Finanz™ tools) for payment planner, an eligibility calculator, or combinations thereof. It may additionally include at least one of a target management or sales management or task management or follow up requests module or combinations thereof. In any of the examples herein, the DSA dashboard may include an online report that may be called on the dashboard to display application status or target status. On the dashboard, there may be links provided to control preferences and also invoke Web 2.0 tools such as chat, blog, wiki and RSS feed. Additionally, the links to Web 2.0 tools may be available across the application allowing the user to access the functionality offered by it at any point of time. For office management and communication assistance, calendar and outlook mail integration may be provided on the dashboard.

One or more functions offered by the dashboard application may be common between different partners of the financial institution. The functionality may remain the same as detailed above for the DSA dashboard. The partners can include retailer, regulator, travel agent, prospector, and broker and agent.

In any of the examples herein, the group function may include at least one of a) a DSA partner finance feature, b) a targets feature, c) a sales feature, d) a tasks feature, e) a follow-up calls feature, a f) a screen preference feature, g) an incentive management feature, or combinations thereof.

In any of the examples herein, the DSA partner finance feature may be used for maintaining and managing the service cost of each service category. It may also be used to derive the total cost calculation based on the achieved target. P/L may be calculated based on incentive received and total cost of services. The targets feature may be used for setting of weekly/monthly/quarterly/yearly targets. Additionally, calculation of expected and actual target achieved may also be set. The target set may be used for forecasting. The sales feature may be used for selling the services and products to the customer. It may additionally be used for opportunity management and sales tracking. The task management feature may be used to add tasks with varied priority and alert mechanism to highlight the task when it is due. The call follow up feature may be used as an interaction mechanism with the DSA to reach out to internal and external resources to provide information or work process management.

The screen preferences may be used to add or remove components on the screen, thereby providing high-level of screen customizations in terms of content management.

In any of the examples herein, the reports function may include at least one of a) an application status feature, b) a target report feature, or combinations thereof.

In any of the examples herein, the application status feature can include providing a snapshot of how many applications are being processed in the system. The feature may also provide the number of active pre-applications or post-applications approvals or pre-screening or approved applications. In any of the examples herein, the target report feature may provide the graph on actual target achieved vs. previously set expected target. It may denote the lead or lag status. The target report feature allows. the reports to be calculated on a month scale or for a specific period.

In any of the examples herein, the tools features may include at least one of a) a payment planner (e.g., Finanz tool) b) an eligibility calculator (e.g., Finanz tool) or c) e-mail or d) calendar (Outlook integration enabled) or combinations thereof.

In any of the examples herein, the payment planner tool may calculate the payment plan for the product that is being offered to the customer, and compare payment schedules between different products and suggest the best one of the customer. The payment planner tool may be used by the DSA to quote the payment details and schedule to the customer. In any of the examples herein, the eligibility calculator tool may be used by the DSA to find out how much loan the DSA may offer to the customer and appropriately generate the application for the customer. The Outlook integration is helpful for the DSA to interact with the partner bank resources and the customers. It may be used for sales promotion as well as official advice. In any of the examples herein, the calendar may be used by DSA to schedule customer interaction meetings or sales promotion meetings and design alerts for important tasks.

In any of the examples herein, the functionality of the DSA should not be read as restrictive in light of the functionality detailed for the DSA. The functionality offered by the DSA may include more/fewer things, and it can depend on the geography in which the DSA operates.

### Example 31

### Exemplary Retailer Functionality

In any of the examples herein, the functionality of the retailer can include at least one a) a partner SSO login function, b) retail partner dashboard function, c) group function, d) reports functions, e) tools function, f) Web 2.0 tools function, or combinations thereof.

In any of the examples herein, the one or more functions which may be finally implemented at the partners end may depend on the requirement of the partners and also the functionality may be configurable based on partner type and requirement. The scope of the functionality should not be read as restrictive in light of the present description.

In any of the examples herein, the partner SSO login function can allow the retail partner to use partner SSO to login to the system. The welcome screen can be the retail dashboard.

In any of the examples herein, the retail dashboard can be a common view for the activities for the retail partner. It can include at least one of a retail team management, a white labeling of products, co branding of products with the bank, or combinations thereof. Tools (e.g., Finanz) may be provided to show product simulation to the customer. The retail dashboard may also include product performance, know-your-customer (“YC”) management, customer creation management, task management and follow up requests, or combinations thereof. In any of the examples herein, the retail dashboard may provide online reports that may be called on the dashboard to display product performance reports or customer creation status. Some functions, like providing links to control preferences and to invoke the Web 2.0 tools may be the same as detailed in the DSA dashboard section.

In any of the examples herein, the group function may include at least one of a) retail team management feature, b) white labeling feature, c) co-branding feature, d) KYC feature, e) customer creation feature, f) product customizations feature, g) store locator feature, h) task management feature, i) screen preference feature, j) follow up calls feature, or combinations thereof.

In any of the examples herein, the retail team management feature may include sales group or marketing group and services group. Each of these groups may be managed by the individual workflow. In any of the examples herein, the white labeling feature may enable the retail partner to provide different services or selling FMCG products tied up with collaborators and will sell product bundles where finance was provided by the partnering bank.

In any of the examples herein, the co-branding feature may enable the retail partner to tie up with collaborators and the partner bank to provide customized products; promote and brand jointly.

In any of the examples herein, the KYC feature may enable the retail partner portal to provide KYC norms and may include online KYC data collection. In any of the examples herein, the product customizations feature may enable the retailers to provide product maintenance and customization functions. In any of the examples herein, the task management feature may enable the retailer to add tasks with varied priority and alert mechanism to highlight the task when it is due. The screen preference feature may enable the retailer to use call follow up mechanism with the retail partner to reach out to internal and external resources to provide information or work process management. In any of the examples herein, the follow up calls feature enables the retailer to use screen preferences to add or remove components on the screen. It can provide a high-level of screen customizations in terms of content management.

In any of the examples herein, the reports feature may include at least one of product performance, customer creation status, or combinations thereof.

In any of the examples herein, the product performance report may provide metrics on what is the delta increase/decrease in terms of volume and value over a time frame such as quarterly/half-yearly/yearly. In any of the examples herein, the customer creation status report may provide a snapshot of active applications and at what stage the application is. The report can be at the partner level or rolled up for different partners to give a consolidated view.

In any of the examples herein, the tool feature may include at least one of a) product simulator (e.g., Finanz tool) or b) s-mail or c) calendar (Outlook integration) or combinations thereof.

In any of the examples herein, the product simulator may simulate the outcome of a product using financial (e.g., Finanz) tools. The Outlook integration may enable the retail partner to interact with the partner bank resources and the customers. It may be used for sales promotion as well as official advices. The calendar may be used by the retail partner to schedule customer interaction meetings, sales promotion meetings and design alerts for important tasks.

In any of the examples herein, the functionality of the Web 2.0 tools can be the same as detailed elsewhere herein.

In any of the examples herein, the functionality of the retailer should not be read as restrictive in light of the functionality detailed for the retailer in the above section. The functionality offered by the retailer may include more or fewer things, and it can depend on the geography in which the retailer operates.

### Example 32

### Exemplary Regulator Functionality

In any of the examples herein, the functionality of the regulator may include at least one of a) a partner SSO login function, b) regulator partner dashboard, c) group function, d) reports functions, e) tools function, f Web 2.0 tools function, or combinations thereof.
In any of the examples herein, the one or more functions that may be finally implemented at the partners end may depend on the requirement of the partners and also the functionality may be configurable based on partner type and requirement. The scope of the functionality should not read as restrictive in light of the present description.

In any of the examples herein, the partner SSO login function can allow the regulator partner to use partner SSO to login to the system. The welcome screen can be the regulator dashboard.

In any of the examples herein, the regulator dashboard function can be a common view for the activities for the regulator partner; It may include a regulator team management, bank performance comparison and central bank reporting feature, or both. It can also include at least one of a compliance management, a task management and follow up requests, or combinations thereof. In any of the examples herein, the regulator function may provide an online report that may be called on the dashboard to display bank performance or compliance status. Other functions like providing links to control preferences & to invoke the Web 2.0 tools may be the same as detailed in the DSA dashboard section.

In any of the examples herein, the group function may include at least one of a) bank performance measurement feature, b) compliance management feature, c) task management feature, d) screen preference feature, e) follow up calls feature, or combinations thereof.

In any of the examples herein, the bank performance measurement feature allows the retailer to list out the delta increment/decrement in the balance statement or quarterly report or statement of income or statement of credit or statement of deposit. The compliance management feature can include managing the compliance of the geographically located bank branches to comply with different regulatory compliances. The task management feature may be used to add tasks with varied priority and alert mechanism to highlight the task when it is due. The follow up call feature can include screen preferences option which may be used to add or remove components on the screen. It may provide high-level of screen customizations in terms of content management.

In any of the examples herein the reports function may include at least one of a) reporting tool feature (Central Bank Reporting), b) reporting module feature, c) bank performance report feature, or combinations thereof.

In any of the examples herein, the reporting tool may be used to prepare the report for the central (e.g., regulating) bank. The reporting module feature may have reports which will be generated on particular time schedule and frequency. The bank's performance feature may be used to measure the banks performance in graph over a yearly trend on various key financial dimensions.

In any of the examples herein, the tools function may include at least one of a) e-mail feature, b) calendar feature (Outlook integration enabled), or combinations thereof.

In any of the examples herein, the e-mail feature can comprise an Outlook integration capability for the regulator partner to interact with the partner bank resources and the customers. It may be used for sales promotion as well as official advice. The calendar feature may be used by regulator partner to schedule customer interaction meetings or sales promotion meetings and design alerts for important tasks.

In any of the examples herein the functionality of the Web 2.0 tools is same as detailed elsewhere herein.

In any of the examples herein, the functionality of the regulator should not be read as restrictive in light of the functionality detailed for the regulator in the above section. The functionality offered by the regulator may include more or fewer things, and it may depend on the geography in which the regulator operates.

### Example 33

### Exemplary Travel Agent Functionality

In any of the examples herein, the functionality of the travel agents may include at least one of a) partner SSO login function, b) travel partner dashboard function, c) group function, d) reports function, e) tools function, f) Web 2.0 tools function, or combinations thereof.

In any of the examples herein, the one or more functions which may be finally implemented at the partners end may depend on the requirement of the partners and also the functionality may be configurable based on partner type and requirement. The scope of the functionality should not read as restrictive in light of the present description.

In any of the examples herein, the partner SSO login function can allow the travel partner to use partner SSO to login to the system. The welcome screen can be the travel dashboard.

In any of the examples herein, the travel dashboard function can be a common view for the activities for the travel partner. It may include at least one of a travel team management, customer tour packages, or combinations thereof. It may also include sales management and/or task management and follow up requests. In any of the examples herein, the travel dashboard may include an online report that may be called on the dashboard to display application status. Other functions, like providing links to control preferences and to invoke the Web 2.0 tools, may be the same as detailed in DSA dashboard section.

In any of the examples herein, the group function may include at least one of a) customize tour packages feature, b) sales target management feature, c) sales management feature, d) task management feature, e) screen preference feature, f) follow up calls feature, or combinations thereof.

In any of the examples herein, the customize tour package feature may design the travel tour with the package attributes. The sale target management feature may send an offer to the customer. Once the customer accepts the offer, an opportunity record may be created, and sales follow up is carried out through sales management. The sale management feature may be used for selling the tour packages to the customer. It may be used for opportunity management and sales tracking. The task management feature may be used to add tasks with varied priority and alert mechanism to highlight the task when it is due. The screen preference feature may include call follow up option as an interaction mechanism with the travel partner to reach out to internal and external resources to provide information or work process management. The follow up calls feature may be used to add or remove components on the screen. It may provide high-level of screen customizations in terms of content management.

In any of the examples herein, the reports function may include at least one of a) application status report feature, b) weather & alert report feature, or combinations thereof.

In any of the examples herein, the report function may give the status of the number of applications that are active in the system, which can include the number of active pre-applications or post-applications or approvals or pre-screening or approved applications. The weather and alert report feature may provide weather forecast and timely alerts to customers.

In any of the examples herein, the tools function may include at least one of a) payment calculator feature (Finanz Tools) or b) an e-mail feature or c) a calendar feature (Outlook integration) or combinations thereof.

In any of the examples herein, the travel partner may design the tour payment for the customer providing flexibility and affordability and tools (e.g., Finanz tools) may be used to provide payment calculation. The Outlook integration may enable the travel partner to interact with the partner bank resources and the customers. It may be used for sales promotion as well as official advices. The calendar feature may be used by travel partner to schedule customer interaction meetings or sales promotion meetings and design alerts for important tasks.

In any of the examples herein the functionality of the Web 2.0 tools can be the same as detailed elsewhere herein.

In any of the examples herein, the functionality of the travel agents should not be read as restrictive in light of the functionality detailed for the travel agents in the above section. The functionality offered by the travel agents can include more or fewer things, and it can depend on the geography in which the travel agents operate.

### Example 34

### Exemplary Prospect Partner Functionality

In any of the examples herein, the functionality of the prospect partner may include at least one a) partner SSO login function, b) prospect partner dashboard function, c) group function, d) reports functions, e) tools function, f) Web 2.0 tools function, or combinations thereof.

According to one embodiment of the present technique, the one or more functions that may be finally implemented at the partners end may depend on the requirement of the partners and also the functionality may be configurable based on partner type and requirement. The scope of the functionality should not be read as restrictive in light of the present description.

In any of the examples herein, the partner SSO login function can allow the prospect partner to use partner SSO to login to the system. The welcome screen can be the prospect dashboard

In any of the examples herein, the prospect dashboard function can be a common view for the activities for the prospect partner. It may include at least one of a prospect team management, product management, service offering partnering with the bank, or combinations thereof. Finance tools (e.g., Finanz tools) may be provided to show product simulation to the prospect. It may also include at least one of a subscription management, prospect relationship management, task management, follow up requests feature, or combinations thereof. In any of the examples herein, the prospect dashboard may provide an online report that may be called on the dashboard to display service reports or prospect application status. Other functions, like providing links to control preferences and to invoke the Web 2.0 tools may be the same as detailed in the DSA dashboard section. In any of the examples herein, the group functions may include at least one of a) prospect capture and creation feature, b) product bundling feature, c) product subscription feature, d) bill payment feature, e) prospect relationship maintenance feature, f) task management feature, g) screen preference feature, h) follow up calls feature, or combinations thereof.

In any of the examples herein, the prospect creation and management feature may include capturing the basic information of the prospect and relationship with the bank. The system may keep track of the previously used services by the prospect and provide automatic data fill for repeat transactions. The product bundling feature may allow product bundling and sending of offers to prospects to become customer's products and services of the bank. The product subscription feature may capture prospect data and create application id of the service it offers to the prospect. If the subscription gets repeated, the prospect portal may capture further information to convert the prospect into customer. The bill payment feature may facilitate easy e-bill payment for prospects. The prospect relationship maintenance feature may provide inputs for cross-selling up-selling. The task management feature may be used to add tasks with varied priority and alert mechanism to highlight the task when it is due. The screen preference feature may use a call follow feature as an interaction mechanism with the prospect partner to reach out to internal and external resources to provide information or work process management. The follow up calls feature may include screen preferences to add or remove components on the screen, thereby providing a high-level of screen customizations in terms of content management.

In any of the examples herein, the report feature may include a) product & service report feature, b) prospect application status report feature, or combinations thereof.

In any of the examples herein, the product & service performance report feature may provide metrics on what is the delta increase/decrease in terms of volume and value over a time frame like quarterly/half-yearly/yearly. The prospect application status report feature may give the status of the number of applications that are active in the system like number of active pre-applications or post-applications or approvals or pre-screening or approved application.

In any of the examples herein, the tools function can include at least one of a) product simulator feature (Finanz tool), b) e-mail, c) calendar feature (Outlook integration), or combinations thereof.

In any of the examples herein, financial tools (e.g., Finanz tools) may provide a simulated product to the prospect and increases interest in using the product and starting a relationship with the bank. The Outlook integration feature may enable the prospect partner to interact with the partner bank resources and the customers. It may be used for sales promotion as well as official advices. The calendar feature may be used by prospect partner to schedule customer interaction meetings or sales promotion meetings and design alerts for important tasks.

In any of the examples herein the functionality of the Web 2.0 tools can be the same as detailed elsewhere herein.

In any of the examples herein, the functionality of the prospect partner should not be read as restrictive in light of the functionality detailed for the prospect partner in the above section. The functionality offered by the prospect partner can include more or fewer things, and it can depend on the geography in which the prospect partner operates.

### Example 35

### Exemplary Brokers and Agents Functionality

In any of the examples herein, the functionality of the brokers & agents may include at least one of a) partner SSO login function, b) broker dashboard function, c) group function, d) reports functions, e) tools function, f) Web 2.0 tools function, or combinations thereof.

In any of the examples herein, the partner SSO login function can allow the regulator partner to use partner SSO to login to the system. The welcome screen can be the broker dashboard.

In any of the examples herein, the broker dashboard function can be a common view for the activities for the broker partner. It may include at least of a broker team management, product management, service offering partnering with the bank, or combinations thereof. Financial tools (e.g., Finanz tools) may be provided to show product simulation to the broker. It may also include subscription management, broker relationship management, task management, follow up requests, or combinations thereof. In any of the examples herein, the broker dashboard feature may provide an online report that may be called on the dashboard to display service reports, broker application status. Some functions, like providing links to control preferences and to invoke the Web 2.0, tools may be the same as detailed in DSA dashboard section.

In any of the examples herein, the group function may include at least one of a) incentives/brokerage feature, b) broker finance feature, c) targets feature, d) sales feature, e) tasks management feature, f) follow-up calls feature, g) screen preference feature, or combinations thereof.

In any of the examples herein, the incentive management feature may include brokerage and incentive calculation for all the services provided. Also, there may be tier-wise rates for incentive calculation. The broker management feature may include customer management and account maintenance and also servicing of the account capability. The target feature may be used to set the weekly/monthly/quarterly/yearly targets. It may be used to calculate the expected and actual target achieved and additionally it may be also used for forecasting of target as well. The sale module feature may be used for selling the services and products to the customer. It may be used for opportunity management and sales tracking. The task management feature may be used to add tasks with varied priority and alert mechanism to highlight the task when it is due. The follow-up calls feature may be used as an interaction mechanism with the broker to reach out to internal and external resources to provide information or work process management. The screen preference feature may be used to add or remove components on the screen. It may additionally provide a high-level of screen customizations in terms of content management.

In any of the examples herein, the reports function may include at least one of a) application status feature, b) target reporting feature, or combinations thereof.

In any of the examples herein, the application status feature can give the status of the number of applications that are active in the system, like number of active pre-applications or post-applications or approvals or pre-screening or approved application. The target report feature may provide the graph on actual target achieved vs. previously set expected target. It may denote the lead or lag status. The number of reports may be calculated on a month scale or for a specific period.

In any of the examples herein, the tools feature may include at least one of a) payment planner feature (Finanz tool), b) eligibility calculator feature (Finanz tool), c) e-mail feature, d) calendar feature (Outlook integration), or combinations thereof.

In any of the examples herein, the payment planner feature may be used to calculate the payment plan for the product that is being offered to the customer. These tools may be used by the broker to quote to the customer regarding the payment details and schedule. The eligibility calculator feature may be used by the broker to find out how much loan exposure the broker may offer to the customer and appropriately generate the application for the customer. The outlook integration may be used by the broker to interact with the partner bank resources and the customers. It may be used for sales promotion as well as official advices. The calendar feature may be used by broker to schedule customer interaction meetings, sales promotion meetings and design alerts for important tasks.

In any of the examples herein the functionality of the Web 2.0 tools are same as detailed elsewhere herein.

In any of the examples herein, the functionality of the brokers and agents should not be read as restrictive in light of the functionality detailed for the brokers and agents in the above section. The functionality offered by the brokers & agents can include more or fewer things, and it can depend on the geography in which the brokers and agents operate.

### Example 36

### Exemplary Other Features

In any of the examples herein, a common ecosystem may be created using the integrated partner portal.

The partner portal may play a very critical role as a support system that can make transactions with partners more seamless and efficient. A partner portal may be designed so that it is central to the bank's ecosystem, and includes many different types of partners: suppliers, dealers, selling agents, service agents and partner organizations that sell the bank's products indirectly (like car financiers obtaining finance through the bank).

The entire ecosystem around the bank may be serviceable using the partner portal. This may enlarge the bank's reach, and at the same time make business processes more seamless across the organization. Through the partner portal, the bank may also extend its services, like tying up with insurance companies and selling insurance products to its customers. Claims to the insurance companies may be lodged through the bank's portal, so multiple customer addresses and customer references need not be maintained.

The integrated partner portal may extend the bank's reach. The bank's product reach may be extended to dealers or retailers selling other white goods. Through such white branding, the bank may be able to spread product reach, and through the partner portal, the retailer may service the customer, in terms of providing information about the prospective loan, initiating the loan account opening process, and performing the functions typical of a mortgage brokering house.

The bank may also extend its conventional lines of business. In the future, products including mutual funds and insurance may be made available with retailers like Wal-Mart. As these products are thus made available, purchase may be initiated through partner portal applications.

The integrated partner portal may incorporate cross partner business processes. The mortgage business is achieved through selling agents and partners. The bank is typically involved in a couple of touch points only, whereas the bulk of the leg work is done by the various agencies who feed off this business. The broking firm allows the customers to look at the various products offered by the banks, based on the customers' needs and specifications. The customer verification agent validates the credentials provided. The appraisers appraise the asset to be mortgaged. If everything goes well, the bank may approve the loan, based on the appraisal provided by the appraiser. The loan disbursal in some cases is made to the broker, who may pass on the fund to the customer. If the loan goes bad, the collection agency may be involved. If there is further litigation when the collection agency is unable to recover the money, lawyers are involved to run with the litigation. Thus there may be high involvement of partners in a typical mortgage business cycle. This example brings out the strong case for a partner portal which may be able to bring together the various partners and the bank, across various points in the business process. At several instances in the business process, the process may be further accelerated through collaboration made possible through a partner portal. For example, an appraiser needs a document from the customer to proceed. With the broker being the single point of contact for the customer, the appraiser uses the portal's collaboration capability to link in with the broker to expedite the delivery of the document, to be sourced from the customer.

The integrated partner portal may assist in simplification of globalization and outsourcing procedure. Globalization is ushering in the need to outsource several functions of the bank to other agencies, operating out of different geographies. This may be call center processing, payments processing, PDF statement processing, and salary processing for employees, payables processing for suppliers or reconciliation which needs manual intervention. All these functions may be facilitated by partner organizations, trained on the job. The training as well as the operation may be facilitated through a partner portal. Access may be provided to relevant online training resources for each of the partners performing a specific role. Thus tight control may be established in terms of access and security. The same may be rolled out with ease to the multiple outsourcing organizations which the bank has relationships with.

In another embodiment of the present technique, the integrated partner portal may assist integrating of suppliers with bankers. Even the bank's suppliers who feed off the bank for business may be tied in through the partner portal. Vendors including at least one of a stationary suppliers or marketing collateral suppliers or systems suppliers may enroll through the bank's portal. Even the process of supplier or partner enrollment may be facilitated by the bank's portal. So suppliers trying to establish a relationship with the bank may use the partner portal as a gateway to connect with the bank. Once the relationship is established, business transactions may also get routed through the portal, using the same principal applicable for other agents.

In another embodiment of the present technique, the integrated partner portal may assist in tying up supply with demand. The partner portal may be extended to tie the supply chain to the demand aspect of the chain. This integration may become quite critical, when banks are keen to optimize their business process to reduce their inventory costs. For example, a customer may be able to order checkbooks online using the e-banking or the mobile banking application. The system may later validate the requirement. Once the order from the customer is accepted, it may be automatically routed to the supplier system, producing checkbooks for customers. If there are multiple suppliers involved, based on certain business rules, it may be routed to a particular supplier. The request may also contain possible details of personalization which the customer requires. If the customer reaches the call center to inquire about the status of the checkbook issuance, the call center personnel may be enabled to traverse across system boundaries to view the status of checkbook issuance in the supplier's system (based on access privileges and security). This is another case for cross collaboration within the portal architecture.

The integrated partner portal may be included in the category of Partner Relationship

Management (PRM) applications. A typical partner portal borrows a large part of its functions from the current CRM architecture. In addition, it may also interfaces with the core banking backend where functions like checkbook issue requests are validated. In a typical SOA-scenario partner portals utilize services across different systems, and enable cross system interactions. In such scenarios, even

possible in-house systems may be used to liaise with various suppliers or supply chain management systems tied into the portal architecture.

In any of the examples herein, the security and access may be designed keeping in mind the partner portal architecture. Access to a partner organization may be restricted based on the role the organization plays, the geography in which it operates and the various functions it performs. A partner may have access to the data it creates, or the data created for the partner. The partner may also be barred access to data meant for other partners.

### Example 37

### Exemplary Scenarios

One or more scenarios describing usage of integrated partner portals can be implemented. These scenarios are indicative only, and several such scenarios may be put together based on the exact benefits the bank is looking for, and the readiness of its current set of applications.

### Example 38

### Exemplary Scenarios: Scenario 1

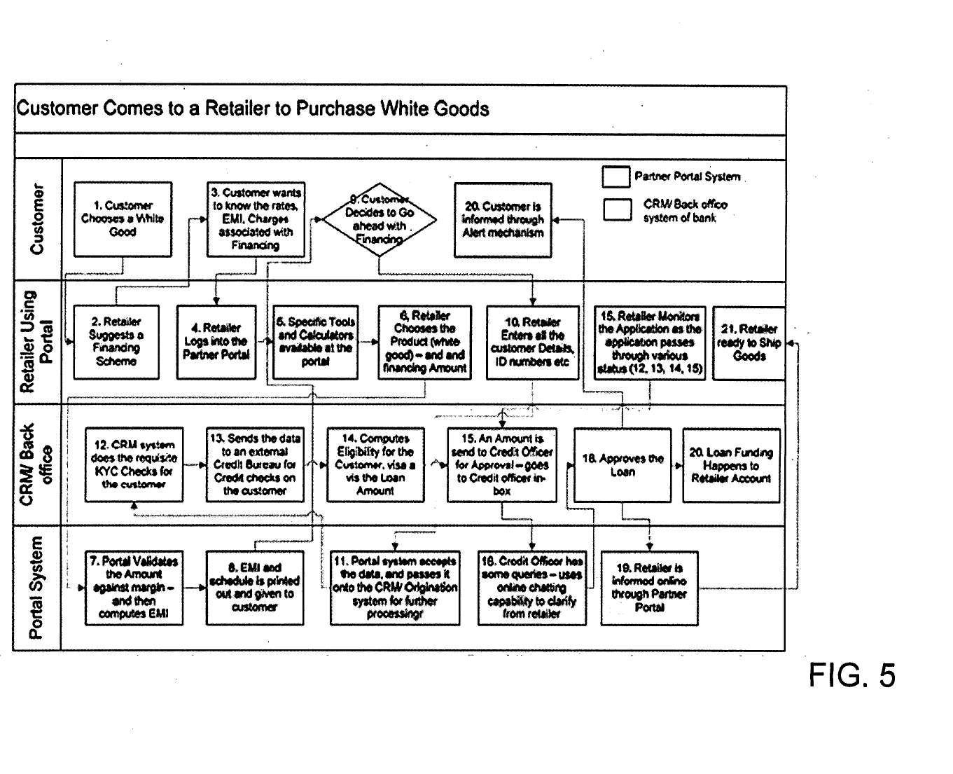

FIG. 5 is a block diagram of a first scenario, illustrating a method of performing white good financing through an integrated partner portal.

Scenario one depicts a bank expanding its reach to customers coming in to purchase white goods from a retail outlet. The retailer has a tie up with the bank, and the bank extends its partner portal system to the retailer through a secured network or even through the Internet. The retailer arranges for a loan with the bank for the customer to finance purchase of a white good, approved by the bank. The entire flow of transactions through the various systems is depicted in the block diagram FIG. 5. The scenario one is beneficial both to the bank as well as the partner (retailer). The retailer may increase sales, by being able to arrange for a very transparent financing option, almost over the counter, whereas the bank benefits because it may increase its reach without really setting up a shop at the retailer's outlet.

### Example 39

### Exemplary Scenarios: Scenario 2

A second scenario illustrates a method of performing of creating and maintaining partner relationships with the bank through the integrated partner portal.

In any of the examples herein, a partner portal can be an exhaustive tool through which the partner may maintain the entire relationship with the bank. An integrated partner portal may be the end to end system which provides partners a platform for doing business with a specified bank. The key functions which such portals may bring to the table can include at least one of the following: a) allowing the partner to register with the bank for a specified business;

b) during the registration process, taking input about the type of business, and/or open specific applications to the partner;

c) allowing the partner to maintain users in the partner organization who would be accessing the portal to conduct business;

d) allowing the partner administrator to give various access rights to different users based on the functions they perform (For each type of the business, there may be predefined roles for the partner organizations to undertake, for example: sales agents, operational managers, sales managers, and so on. The administrator may define various roles and the organization hierarchy, determining the access rights for each user belonging to the partner organization);

e) allowing users, based on their roles, to download their own training materials;

f) establishing policies and guidelines for financing;

g) establishing policies and guidelines for partnership with the bank (the access for this may be limited to managers and made unavailable to general sales agents);

h) providing tools for partners to set targets and sales to be tracked against such targets;

i) facilitating reporting mechanisms through which the partner may be able to monitor various dimensions of the business with the bank. (These can include, for example, a. total sale of the financing product achieved, b. target achieved, c. commissions earned through successful sales, d. number of applications processed, pending, and rejected. The status of pending application, number of applications pending because of pending inputs from the partner organization, e. impact of any promotional offers jointly promoted by the partner and the bank, f. various sale agents who are able to close deals faster and more effectively using the financing options available g. analytics on sales, and the like);

j) providing feedback on the partner services as well as services provided by the bank (Such surveys may be conducted at pre-determined frequencies);

k) integrating tasks, alerts and mails with the desktop application the user typically uses; or combinations thereof.

### Example 40

### Exemplary Scenarios: Scenario 3

A third scenario illustrates a prospect portal capabilities. A partner portal may be extended to a prospect—who is soliciting a relationship with the bank. The portal may be a tool to entice the prospect to look at a deeper relationship with the bank. The bank may offer various products and services—and allow the prospect access to various tools and calculators through which the prospect may model financial needs. The portal may be used to expose certain products and services, which prospects may utilize for a fee. A typical service may be bill payment, or the ability to subscribe to, international publications or international seminars, after paying the requisite fee to the bank. If there is a need to reach such services more than once, the bank may provide for registration of the prospect. This would ensure that the customer information is entered and archived, and may be re-used when the customer makes a second transaction of similar nature. If the service would be performed offline—then the portal generates a service ID, which may be used by the customer across different channels. Such access and functionality for prospects, may facilitate deeper relationships, and may lead to more frequent conversion of prospects into customers.

### Example 41

### Exemplary Other Features

In any of the examples herein, advantages of an integrated partner portal can include: a) the financial sector (bank) may cross-sell products as riders and through direct promotional or clubbed offers, b) the retailer may enjoy increased product sales and group sales due to the large customer base, c) the customers may enjoy the option to choose the best offer from among several similar offers and variances under a single virtual business center, or the like.

In any of the examples herein, the partner portal as an Application Service Provider (ASP) may be provided as a service by a collaborator where infrastructure and application hosting may be provided by a third party. This may facilitate cost saving for the bank and retailer, while on the other hand increasing revenues.

In any of the examples herein, the portal may be used to introduce online collaboration between various partners and the bank's officials, thus increasing the efficiency of a cross functional business process, through systemic support, with business process streamlining as the key focus area.

### Example 42

### Exemplary Implementations

As will be appreciated by those ordinary skilled in the art, the foregoing example, demonstrations, and method steps may be implemented by suitable code on a processor base system, such as general purpose or special purpose computer. It may also be noted that different implementations of the present technique may perform some or all the steps described herein in different orders or substantially concurrently, that is, in parallel. Furthermore, the functions may be implemented in a variety of programming languages. Such code, as will be appreciated by those of ordinary skilled in the art, may be stored or adapted for storage in one or more tangible machine readable media, such as on memory chips, local or remote hard disks, optical disks or other media, which may be accessed by a processor based system to execute the stored code.

### Example 43

### Exemplary Alternatives

The description is presented to enable a person of ordinary skill in the art to make and use the invention and is provided in the context of the requirement for a obtaining a patent. The description includes the best presently-contemplated method for carrying out the present invention. The generic principles of the present invention may be applied to other embodiments, and some features of the present invention may be used without the corresponding use of other features. Accordingly, the present invention is not intended to be limited to the embodiment shown but is to be accorded the widest scope consistent with the principles and features described herein.

It may be desirable to use some of the features of the present invention without the corresponding use of other features.

Accordingly, the description of the present invention may be considered as merely illustrative of the principles of the present invention and not in limitation thereof.

### Example 44

### Exemplary Further Features

In any of the examples herein, the technologies can include further features.

### Example 45

### Exemplary Partner Details

In any of the examples herein, a rich set of features for partner registration, validation, rights/permissions, and incentives (e.g., targets) can be supported. Partner configuration data supporting such features can be stored as part of the portal configuration data.

For example, if a retailer has a complex hierarchy of stores, regional offices, a corporate office, etc., a management tool can be provided to allow hierarchies to be preserved for purposes of management by the partner. A delegate from the partner or sub-division of the partner (e.g., store, region, etc.) can register with the partner portal and be granted administrative rights over an appropriate portion of the hierarchy. Thus, users of a partner organization can directly administer rights for other partner users without having to involve the portal principal (e.g., financial institution).

Incentives can also be set up in a similar manner. For example, partner organizations can provide data concerning individual stores/regions, and the portal principal can specify rules by which the data are transformed into targets for the stores/regions.

A batch mode can be supported by which a partner organization can add a plurality of stores/regions at once. Delegates can be specified. Username/password information can be sent directly to the delegates, who can immediately access the partner portal to conduct business, configure their store/region, register additional users, etc.

### Example 46

### Exemplary Partner-Driven Customer Onboarding

In any of the examples herein, a strength of the partner portal can be its facilitation of partner-driven customer onboarding. For example, a partner organization can bring new customers to the portal principal.

A partner can originate the process of customer creation and validation (e.g., acquiring documents establishing the customer's identity, eligibility, or both). The financial institution can then take care of approval (e.g., via its backend system).

In this way, additional customers are driven to the bank. As described herein, incentives can be offered to those partners bringing such new customers to the bank.

### Example 47

### Exemplary Partner Portal Access

In any of the examples herein, a partner can access the partner portal via the Web (e.g., URL). Although direct access by the customer can be achieved, a partner can access the portal on behalf of the customer. For example, when selling a product that includes some portal principal involvement (e.g., a loan), the partner can log into a portal URL by which they can start a credit check, know-your-customer process, eligibility check, and the like for the customer. In this way, a new customer can be brought to the portal principal, or new business for an existing customer can result.

### Example 48

### Exemplary Co-Branding

In any of the examples herein, a partner can engage in co-branding with the portal principal. The power of co-branding can thus be used in the financial context, brining synergies between the partner and the portal principal.

For example, a customer may be drawn to doing business with a partner based on its association with the financial institution, which may have an established brand.

Co-branding can take the form of a financial institution name, logo, or other indicia of the financial institution in on-line banner advertisements, on-line forms, on-line splash pages, or the like. Such indicia can include active links directly to a web page for purchasing a financial product from the partner or bank, or for learning more information about such products. Products can be bundled so that indicia link to a web page for purchasing a non-financial product that is bundled with or results in provision of a financial product (e.g., a loan to buy a non-financial product, currency exchange for a vacation, etc.).

### Example 49

### Exemplary Added Customer Benefits due to Bank Relationship

In any of the examples herein, a customer can be provided added benefits due to the partner's relationship with the bank. For example, when purchasing products from a partner, benefits can be advertised and or provided to the purchasing customer stemming from the bank relationship. Bundling and/or add-ons in package deals can be provided via the portal to draw additional customers to the partner.

For example, if a financial product of the financial institution is involved in a transaction for a partner product, favorable treatment can be given. For example, a favored rate (e.g., interest rate, currency exchange rate, or the like), expedited processing, or the like can be given. In this way, the customer can be provided an added reason to select the partner over other partners (e.g., not associated with the bank), even when deciding about non-financial products.

The partner portal can present a user interface by which the partner originates a product purchase from the financial institution by a user. As described herein, responsive to origination of the product purchased by the partner, the partner portal can provide, to the user, a bundled benefit to the user.

### Example 50

### Exemplary Partner Incentives

In any of the examples herein, a partner can be given incentives for engaging in activities that benefit the portal principal. Such incentives can be built into the partner configuration process.

Setting up the details for a partner can comprise setting up an incentive scheme type for the partner.

The partner can then be rewarded based on an amount of business done by the partner through the partner portal according to the incentive scheme type. For example, the incentive scheme can track new customers brought to the bank, and the partner can be rewarded by paying a benefit to the partner based on how many new customers are brought to the bank.

The possibilities are limitless. For example, a brokerage can be paid as a percentage of products sold. The partner portal can provide comprehensive management and reporting tools to allow the partner to track progress to incentive targets (e.g., by store, region, or the like). The tools can also drive determining and providing compensation to the partner upon meeting the targets, along with reports showing actual results (e.g., by quarter, year, or the like).

### Example 51

### Exemplary Query Push to Independent Service Providers

In any of the examples herein, independent service providers can be incorporated into the partner portal. For example, if a customer has a question about a particular financial product offered by the financial institution, the independent consultant can provide advice regarding such a product.

The partner portal can support direct communication between customers and independent service providers. Tools such as on-line chat (e.g., instant messaging) can be incorporated into the portal, by which a customer is instantly connected to an independent consultant who can provide relevant advice. The portal can track such a connection between the customer and the consultant, including the amount of time spent, volume of information exchanged, and content of information exchanged. Such information can be retained for proof of regulatory compliance, compensation to the consultant, and the like.

### Example 52

### Exemplary Partner Scenario: Travel Agent

Although any number of other scenarios are possible, a partner involving a travel agent is illustrative of various features supported by an exemplary partner portal. In the travel agent scenario, the travel agent may offer any number of products for purchase by customers, including vacation packages and the like.

By associating itself with the partner principal (e.g., a financial institution), the travel agent can offer additional benefits to its customers. For example, a customer may see that a particular vacation package has a large price tag and consider why a particular travel agent should be receiving the customer's business, expecting beneficial treatment or some adjustment in the price.

A travel agent can engage the features of the portal to provide add-ons and benefits from the partner principal as part of the vacation package. For example, a travel card, travel insurance (e.g., at a reduced rate or free for x person(s)), a favorable exchange rate (e.g., for the first χ,OOO Euros), a beneficial rate for traveler's cheques, and the like can be offered.

### Example 53

### Exemplary Partner Portal Processes

The partner portal can facilitate processes involving both a partner(s) and the portal principal.

In some of the examples, Finacle™ Customer Relationship Management technology is used, but other CRM software can be used (e.g., as part of a back end system supporting the partner portal).

As shown in the various illustrations, workflow can be divided between the portal and a supporting backend (e.g., Finacle Core, Finacle CRM, or the like).

In some conventional banking operational CRM environments, direct selling and servicing customers were predominant activities of all the banks. There were hardly any third parties involved in any banking operations. With limited offerings and a small customer base this model of direct delivery proved effective.

Over a period of time, banks have increased their services beyond traditional products. Their customer base expanded as business crossed international boundaries. Banks started adopting various indirect servicing and channel partners. This proved very effective in handling a large customer base having geographic distribution. Partner Portal solutions also improve the operational aspects when banks operate in wide range of product and service and handle large volumes. Many banks have adopted Partner Management systems that are either on-premise applications, hosted, or follow software-as-a-service (SaaS) deployment model.

Partner management is a core business function by the bank to strategize and enhance channel operations and reduce cost. Which means Partner Portal can be used in recruitment of suitable partner, managing relationship based partners, contracting and managing entitlements of various partners across channel eco system.

Managing Partner Training and Knowledge Base

Partner on-boarding can be followed by detail training of the partner to sell the product and services to the bank's customers. It can include to providing real-time self-learning via the Partner Portal about new products and portal access to an in-depth knowledgebase. Banks indulge in broadcasting news, product launches and market data to keep partners up-to-date on marketing trends aiding partners to service and right sell to customers.

Co-Partnering and Marketing Management

Banking products and services require often more than one partner to participate at multiple stages of the selling or servicing life cycle. Banks generally follow sub partnering or co-partnering route in such complex servicing models. There are various Co-Partnering and Marketing Management models that can be adopted in the partner portal to manage revenue sharing among multiple service partners.

Partner Sales Management

Bank business heads have revenue targets. Revenue targets are converted into product selling targets and assigned to banking executives in charge of partner channels. Partners are then given targets which are measured, monitored, forecasted and reviewed Q-on-Q. The partner portal can play an important role in managing targets and sales pipelines.

Prospect Management

A partner portal can extend beyond the standard partner-customer boundaries to attract new onlookers. Onboard product seeking prospects in an online on-boarding technique and self origination. Banks are finding this automated prospect management useful to attract new customers with very less investment cost.

Partner Evaluation and Control

A key role of managing through a partner portal is to implement banking policies that need adherence based on the region of operations and prevalent regulations. Partners need to be monitored for their quality of service, transaction transparency, etc. Adequate mechanisms should allow bank to take suitable corrective actions like revoking service rights, blacklisting partners, etc.

### Example 54

### Exemplary Partner Empanelment

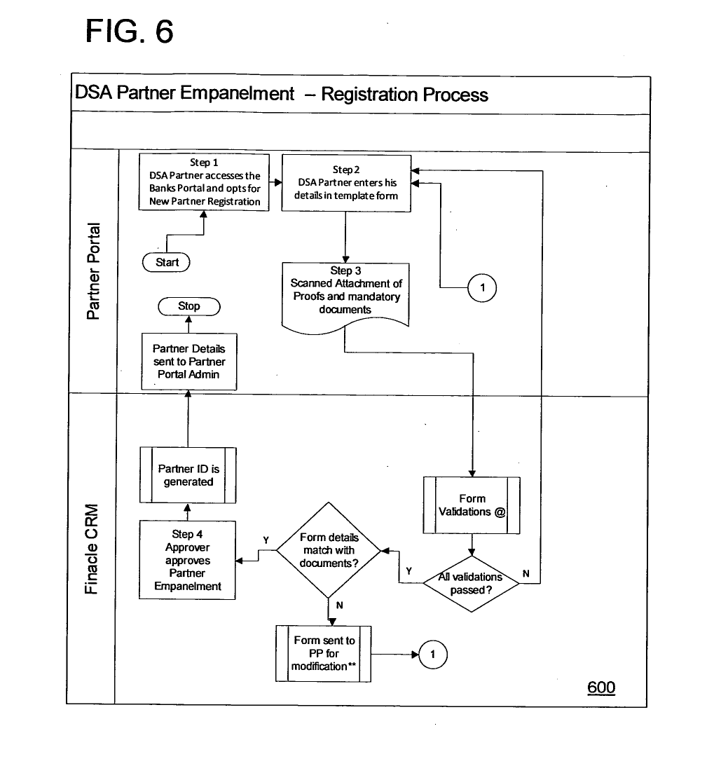

FIG. 6 is a diagram of an exemplary process 600 for partner empanelment (e.g., registration process) via a partner portal. The various acts shown can be used to set up new partners and set up master details for the partner.

Although the example is targeted to DSA partner empanelment, other partners can use a similar system. However, empanelment can be tailored based on the type of partner being empaneled.

Partner Empanelment can include the registration process performed in a partner portal system. Banks work with various channel partners to service and sell products to customers, like Direct Sales Agent, Retail Partner, Regulatory Partner, Travel Agent Partner, Insurance Partner, Broker Partner etc. These partners actively visit the bank's portal and seek partnership to provide services at competitive pricing.

Partners access the bank website to understand the service and product offering of the bank. The partner portal has a step wise process to empanel a partner. In the first step, a partner accesses the bank portal and opts for partnership in qualifying category. In the second step, the partner enter the details as mentioned in the data entry screen (e.g. Partner Name, Product specialties, Contact details, Office Address, Mailing Address, Work Address, Additional details, etc.).

In step 3, the partner uploads scanned documents of proof required for empanelment verification. After submission of the partner details and documents, the information is transmitted to Finacle CRM where further validation and processing is performed. In CRM, if validation fails, then the form is sent back to the partner portal with an Error (Exception) code. The partner can correct the details and resubmit.

Once the data validation check is passed, the completed partner details reach the CRM Partner Manager for approval. In Step 4 the CRM Partner Manager checks the physical supportive documents along with the submitted documents. If there is any discrepancy, the manager can reject the approval and send back the application for clarification or correction. After document checking is completed, the CRM Partner Manager approves the application in this step.

Step 4, completion in CRM system, automatically generates a unique Partner ID and sends the confirmation and Partner ID details to the partner portal. The partner portal System Administrator associates the Partner ID to set up userid, access rights, roles and responsibilities of the empanelled partner.

### Example 55

### Exemplary Product Selling Restrictions

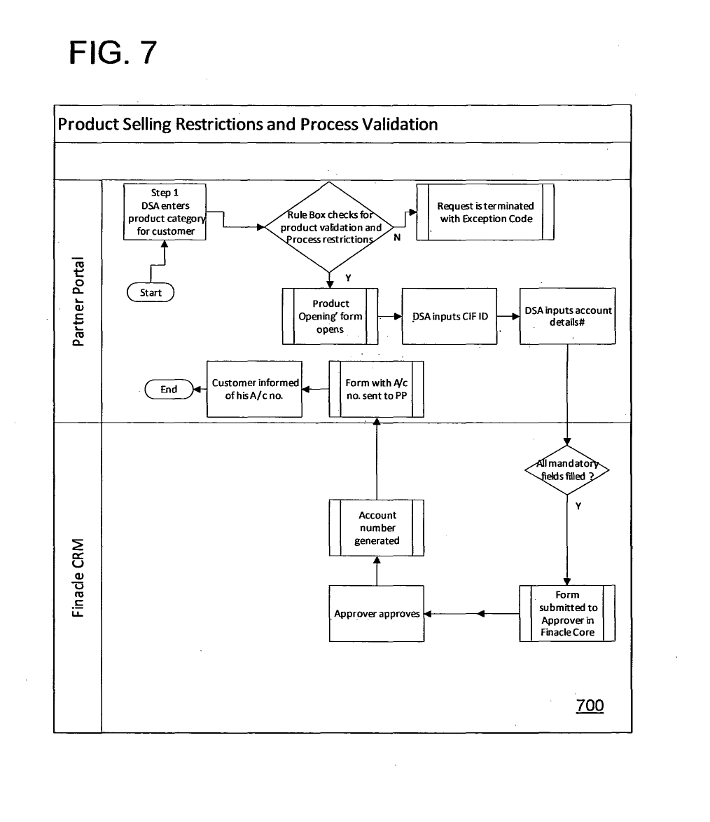

FIG. 7 is a diagram of an exemplary process 700 for product selling rules and restrictions via a partner portal. Restrictions can be based on geography, relationship between the parties, and other concerns. Government and other regulations are observed via the process. For example, some regions may prohibit sale of certain (e.g., insurance or investment) products or require an independent consultation before such a sale takes place. If the proper process has not been completed, the request can be terminated with an appropriate exception code. The sale may be prohibited or may continue upon fulfillment of the requisite process actions.

The partner portal application can be built on a framework that provides a holistic workflow and rule based setup. It governs the business processes and actions of different partner. For example, a DSA cannot sell a loan to a customer for buying white goods (but a qualified retailer can). The system would throw an exception and the application would not proceed further. As per banking regulations in many countries, insurance partners may not be able to sell banking products. Such restrictions and validation on selling violations will be governed by the partner portal rule setup, which is configurable.

### Example 56

### Exemplary Independent Consultant

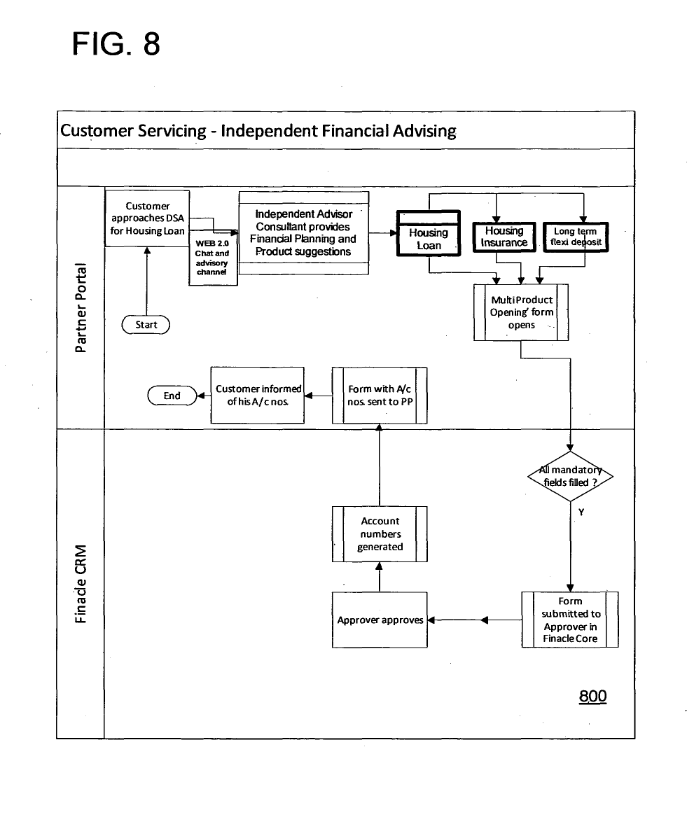

FIG. 8 is a diagram of an exemplary process 800 for independent financial advising via a partner portal. Such a scenario can be appropriate for product selling restrictions as described above, or as part of customer queries.

In the example, an independent consultant can participate in the customer servicing process via the portal in the form of chat (e.g., instant messaging and the like) to answer customer queries, provide consultation, or the like. The consultant can be compensated as permitted by applicable regulations and contracts.

Banks can assist the customer in understanding and defining the customer's financial goals. In many cases, customers engage with an “Independent Financial Advisor” who prepares the financial planning for the customer and advocate products that the customer needs.

The partner portal can be used for engaging the customer and connecting to the Independent Advisor. The initial step starts with on-boarding the customer and understanding the immediate needs.

There can be many Independent Financial Advisors who are associated with the bank and can be reached through partner portal Web 2.0, advisory services and chat.

Using Web 2.0 online services, the Financial Advisor helps the customer understand the customer's needs better and guides the customer to the right set of products and sets the customer's financial goals with measurable targets.

For example, a customer may approach a DSA for sourcing funds for buying a house. The DSA can perform a brief need analysis and associate the customer with the Independent Financial Advisor. The Financial Advisor prepares a detailed financial planning for the customer and suggests 3 products: a housing loan, housing insurance, and long term flexi deposit.

Once the financial planning is completed, the DSA captures those multi-product opportunities and processes them through the partner portal system. This entire process of customer on-boarding, financial advising and product origination can be performed in the partner portal using various workflow and business processes.

### Example 57

### Exemplary Creation of Customer Information File (CIF) for New Customer

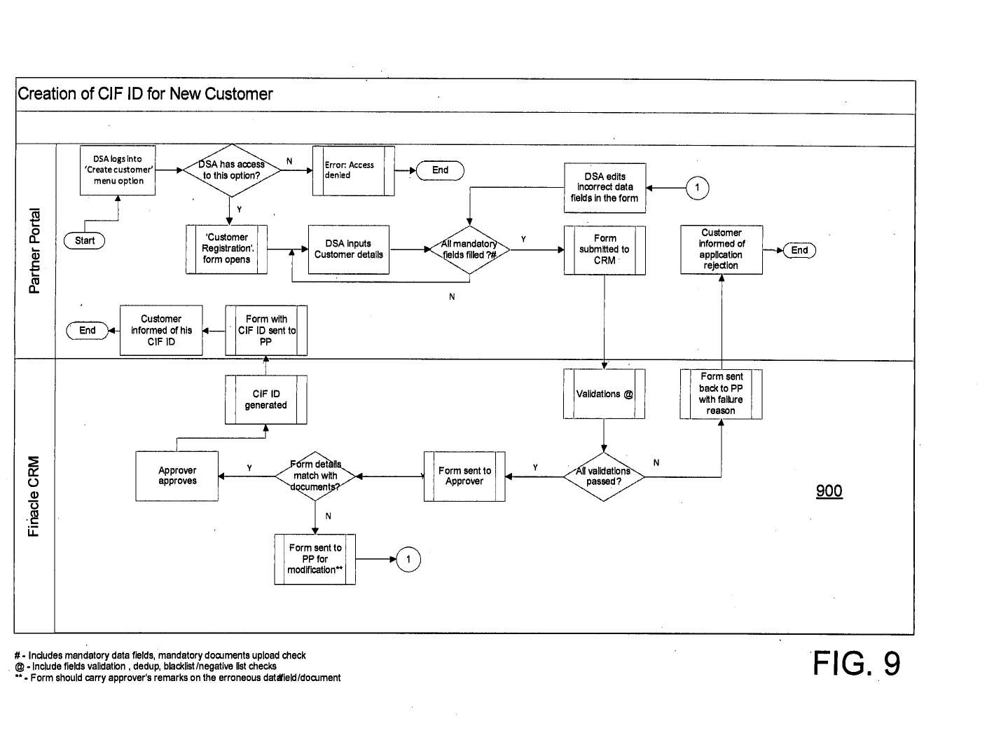

FIG. 9 is a diagram of an exemplary process 900 for creation of a customer information file via a partner portal. In practice, the CIF need not be a “file” in the data processing sense, but simply a collection of information about the customer, such as account, credit data, and the like.

According to the process, a partner (e.g., DSA) can drive customer onboarding (e.g., customer registration, validation, and the like), thus avoiding delay or confusion related to involving the portal principal in all aspects. However, the portal principal can still influence the process via its CRM system.

### Example 58

### Exemplary Maintenance of (CIF Details) for Existing Customer

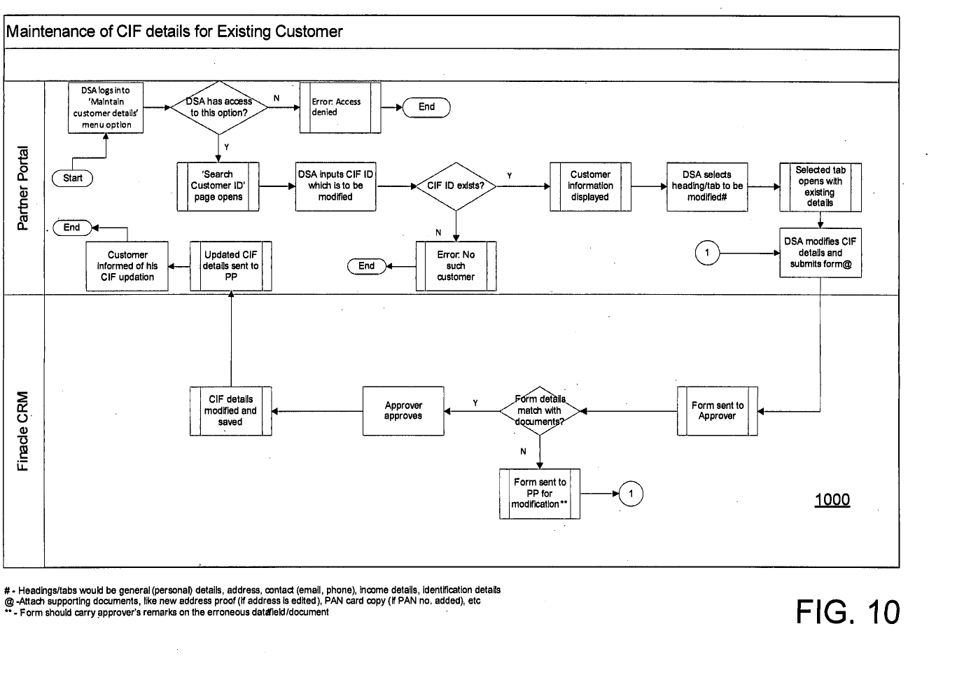

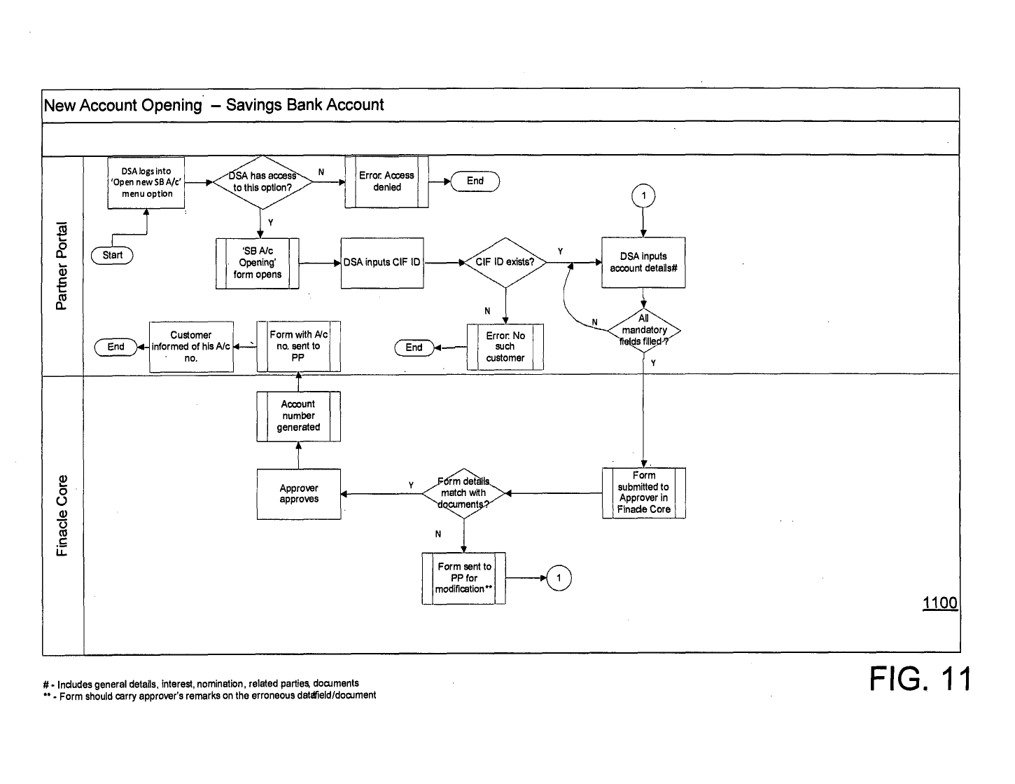

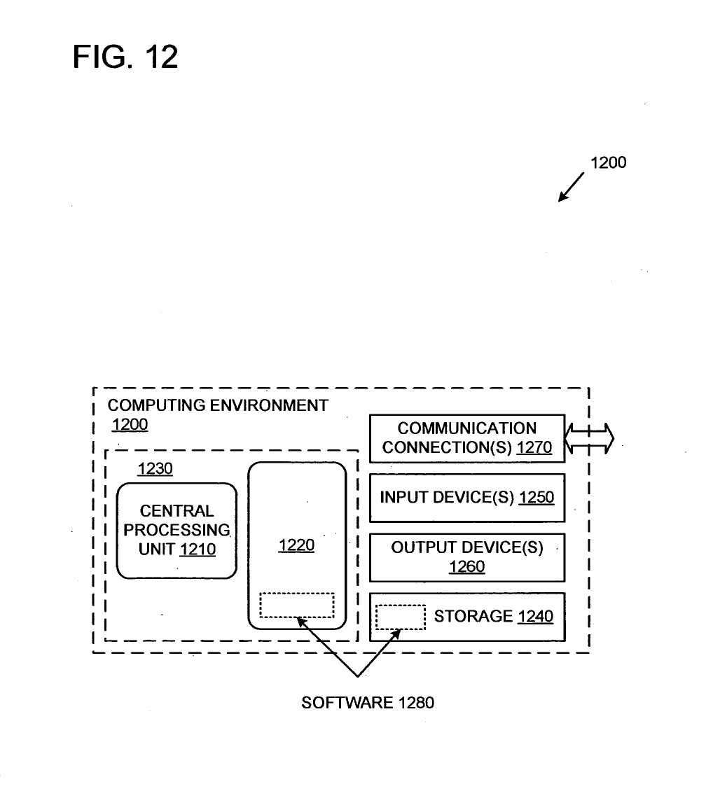

FIG. 10 is a diagram of an exemplary process 1000 for maintaining customer information file details for an existing customer via a partner portal. As above, the CIF need not be a “file” in the data processing sense.

According to the process, a partner (e.g., DSA) can assume the tasks of maintaining customer details, thus avoiding delay or confusion related to involving the portal principal in all aspects.

However, the portal principal can still influence the process via its CRM system.

### Example 59

### Exemplary New Account Opening

FIG. 1 1 is a diagram of an exemplary process 1 100 for opening a new account via a partner portal. Such collaborative workflow can lead to more account openings.

### Example 60

### Exemplary Computing Environment

The techniques and solutions described herein can be performed by software, hardware, or both of a computing environment, such as one or more computing devices. For example, computing devices include server computers, desktop computers, laptop computers, notebook computers, netbooks, tablet devices, mobile devices, and other types of computing devices.

FIG. 12 illustrates a generalized example of a suitable computing environment 1200 in which the described technologies can be implemented. The computing environment 1200 is not intended to suggest any limitation as to scope of use or functionality, as the technologies may be implemented in diverse general-purpose or special-purpose computing environments. For example, the disclosed technology may be implemented using a computing device (e.g., a server, desktop, laptop, hand-held device, mobile device, PDA, etc.) comprising a processing unit, memory, and storage storing computer-executable instructions implementing the business value articulation described herein. The disclosed technology may also be implemented with other computer system configurations, including hand held devices, multiprocessor systems, microprocessor-based or programmable consumer electronics, network PCs, minicomputers, mainframe computers, a collection of client/server systems, and the like. The disclosed technology may also be practiced in distributed computing environments where tasks are performed by remote processing devices that are linked through a communications network. In a distributed computing environment, program modules may be located in both local and remote memory storage devices

With reference to FIG. 12, the computing environment 1200 includes at least one processing unit 1210 coupled to memory 1220. In FIG. 12, this basic configuration 1230 is included within a dashed line. The processing unit 1210 executes computer-executable instructions and may be a real or a virtual processor. In a multi-processing system, multiple processing units execute computer-executable instructions to increase processing power. The memory 1220 may be volatile memory (e.g., registers, cache, RAM), non-volatile memory (e.g., ROM, EEPROM, flash memory, etc.), or some combination of the two. The memory 1220 can store software 1280 implementing any of the technologies described herein.

A computing environment may have additional features. For example, the computing environment 1200 includes storage 1240, one or more input devices 1250, one or more output devices 1260, and one or more communication connections 1270. An interconnection mechanism (not shown) such as a bus, controller, or network interconnects the components of the computing environment 1200. Typically, operating system software (not shown) provides an operating environment for other software executing in the computing environment 1200, and coordinates activities of the components of the computing environment 1200.

The storage 1240 may be removable or non-removable, and includes magnetic disks, magnetic tapes or cassettes, CD-ROMs, CD-RWs, DVDs, or any other computer-readable media which can be used to store information and which can be accessed within the computing environment 1200. The storage 1240 can store software 1280 containing instructions for any of the technologies described herein.

The input device(s) 1250 may be a touch input device such as a keyboard, mouse, pen, or trackball, a voice input device, a scanning device, or another device that provides input to the computing environment 1200. For audio, the input device(s) 1250 may be a sound card or similar device that accepts audio input in analog or digital form, or a CD-ROM reader that provides audio samples to the computing environment. The output device(s) 1260 may be a display, printer, speaker, CD-writer, or another device that provides output from the computing environment 1200.

The communication connection(s) 1270 enable communication over a communication mechanism to another computing entity. The communication mechanism conveys information such as computer-executable instructions, audio/video or other information, or other data. By way of example, and not limitation, communication mechanisms include wired or wireless techniques implemented with an electrical, optical, RF, infrared, acoustic, or other carrier.

The techniques herein can be described in the general context of computer-executable instructions, such as those included in program modules, being executed in a computing environment on a target real or virtual processor. Generally, program modules include routines, programs, libraries, objects, classes, components, data structures, etc., that perform particular tasks or implement particular abstract data types. The functionality of the program modules may be combined or split between program modules as desired in various embodiments. Computer-executable instructions for program modules may be executed within a local or distributed computing environment.

Storing in Computer-Readable Media

Any of the storing actions described herein can be implemented by storing in one or more computer-readable media (e.g., computer-readable storage media or other tangible media).

Any of the things described as stored can be stored in one or more computer-readable media (e.g., computer-readable storage media or other tangible media).

Methods in Computer-Readable Media

Any of the methods described herein can be implemented by computer-executable instructions in (e.g., encoded on) one or more computer-readable media (e.g., computer-readable storage media or other tangible media). Such instructions can cause a computer to perform the method. The technologies described herein can be implemented in a variety of programming languages.

Methods in Computer-Readable Storage Devices

Any of the methods described herein can be implemented by computer-executable instructions stored in one or more computer-readable storage devices (e.g., memory, CD-ROM, CD-RW, DVD, or the like). Such instructions can cause a computer to perform the method.

Alternatives

The technologies from any example can be combined with the technologies described in any one or more of the other examples. In view of the many possible embodiments to which the principles of the disclosed technology may be applied, it should be recognized that the illustrated embodiments are examples of the disclosed technology and should not be taken as a limitation on the scope of the disclosed technology. Rather, the scope of the disclosed technology includes what is covered by the following claims.

We therefore claim as our invention all that comes within the scope and spirit of these claims:

1. A banking portal system comprising:
a processor;
memory coupled to the processor;
a configuration storage comprising configuration data stored in a computer-readable storage medium, the configuration data comprising user information for a plurality of users registered with the banking portal system, wherein the plurality of users are from partner organizations of different business partner types comprising retail partner, regulator partner, and prospect partner; and
portal functionality for conducting transactions with a bank in conjunction with the partner organizations, wherein the portal functionality comprises retail-partner-specific functionality, regulator-partner-specific functionality, and prospect-partner-specific functionality.

2. The banking portal system of claim 1, wherein the configuration storage indicates a partner type for respective of the partner organizations.

3. The banking portal system of claim 1, wherein the banking portal system is coupled to a backend processing system for the bank.

4. The banking portal system of claim 1, wherein the banking portal system is implemented as a website collecting information from and providing information to the partner organizations by which the partner organizations access the portal functionality.
